(19) United States
(12) Patent Application Publication
(10) Pub. No.: US 2007/0166677 A1
(43) Pub. Date: Jul. 19, 2007

(54) Adaptive computer-based evaluation with constrained genetic algorithm

(76) Inventor: Iyad Suleiman, Nazareth (IL)

Correspondence Address: PEARL COHEN ZEDEK LATZER, LLP, 1500 BROADWAY 12TH FLOOR, NEW YORK, NY, 10036, US

(21) Appl. No.: 11/638,690

(22) Filed: Dec. 14, 2006

(30) Foreign Application Priority Data
Dec. 18, 2005 (IL) 172657

(51) Int. Cl. G09B 19/00; G09B 9/00

(52) U.S. Cl. 434/236; 434/247

(57) ABSTRACT

A computer-based method for evaluating a subject, based on presenting a session of evaluation exercises to the subject and automatically evaluating the subject's performance. The method comprises: providing a server, a data storage provided on said server, the storage provided with database that comprises personal identity data about the subject and an exercise library comprised of a plurality of exercises, processing means on said server for processing the subject's performance data and evaluating the subject and at least one of a plurality of computers having display means and user interface, each computer connected over a network to the server; the computer including a subject assessment module; retrieving a session of exercises from the server and presenting it to the subject on the display means, receiving input from the subject through the user interface, and transmitting the input to the processing means of the server for analyzing, using a genetic algorithm by the server the algorithm comprising a fitness evaluation function applied to a set of chromosomes, a chromosome comprising a scoring technique applied to a set of possible exercise sessions to select a suitable exercise session based on the subject's performance, wherein the genetic algorithm operates under constraints.

### CROSS REFERENCE TO RELATED APPLICATIONS

This application claims priority from Israeli Patent Application Number 172657, filed on Dec. 18, 2005, which is incorporated in its entirety herein by reference.

### Field of the Invention

The present invention relates to evolutionary programming, more particularly it relates to computer-based genetic algorithms for assessment and evaluation.

### BACKGROUND OF THE INVENTION

Assessment of a person's abilities and skills is an important task for many organizations. Examples include evaluating a child's readiness for school or determining an employee's aptitude for a position. Assessment involves various parameters related to the test subject's aptitude, such as motor skills, linguistic development, or deductive capabilities. Assessment is carried out by many bodies, such as public education systems, commercial testing companies, and recruiters.

To facilitate the assessment process, computer-based assessment systems are used. A recent innovation is an adaptive computer-based assessment tool that analyzes the subject's skill and dynamically adapts the assessment tests accordingly. This tool is disclosed by the present inventor, Iyad Suleiman, in US 20040014021, entitled “APPARATUS AND METHOD FOR EVALUATING SCHOOL READINESS.”

In US 20040014021, a computer-based apparatus is used for evaluating school readiness of a child by having the child play a series of games comparing the child's performance with a database of performance results for a population. The apparatus includes a processor for processing the child's performance data, for comparing the performance data with the performance results of the population, and for applying a genetic algorithm (GA) to determine the most appropriate next test for the child.

A GA is a type of optimization technique for finding the best solution to a problem of the kind that has a number of possible solutions. GAs are part of evolutionary computing, which is a rapidly growing area of artificial intelligence inspired by Darwin's theory of evolution. In a GA, a solution is represented as a chromosome. The GA applies genetic operators, such as mutation and crossover, to a population of such chromosomes to evolve a new generation. The fitness of the chromosomes is evaluated to determine whether any of them provides a valid solution. If no suitable chromosome is found, another generation is evolved and evaluated, and so forth.

A problem affecting current adaptive computer-based assessment tools is due to the fact that there are so many possible sets of solutions that a great deal of processing time and processor power are required to reach an optimum or near optimum solution.

The present invention provides an improved GA for adaptive computer-based assessment methods and systems. The improvement consists of applying constraints to the chromosomes so as to optimize the solution set. Two types of constraints are used: hard constraints, which filter out solutions that violate non-negotiable requirements and soft constraints, which carry a penalty, reducing a chromosome's fitness evaluation.

Other objects and advantages of the present invention will become apparent after reading the present specification and reviewing the accompanying drawings.

### BRIEF DESCRIPTION OF THE INVENTION

There is thus provided, in accordance with some preferred embodiments of the present invention, a computer-based method for evaluating a subject, based on presenting a session of evaluation exercises to the subject and automatically evaluating the subject's performance, the method comprising: providing a server, a data storage provided on said server, said storage provided with database that comprises personal identity data about the subject and an exercise library comprised of a plurality of exercises, processing means on said server for processing the subject's performance data and evaluating the subject and at least one of a plurality of computers having display means and user interface, each computer connected over a network to the server; the computer including a subject assessment module; retrieving a session of exercises from the server and presenting it to the subject on the display means, receiving input from the subject through the user interface, and transmitting the input to the processing means of the server for analyzing, using a genetic algorithm by the server the algorithm comprising a fitness evaluation function applied to a set of chromosomes, a chromosome comprising a scoring technique applied to a set of possible exercise sessions to select a suitable exercise session based on the subject's performance, wherein the genetic algorithm operates under constraints.

Furthermore, in accordance with some preferred embodiments of the present invention, the constraints are soft constraints, wherein a soft constraint comprises a penalty value that is summed into the fitness evaluation function when the constraint is violated.

Furthermore, in accordance with some preferred embodiments of the present invention, the constraints are hard constraints comprising a set of requirements applied to proposed sessions to filter out sessions that do not meet the set of requirements.

Furthermore, in accordance with some preferred embodiments of the present invention, the hard constraints are applied at the beginning of the genetic algorithm.

Furthermore, in accordance with some preferred embodiments of the present invention, the constraints are both hard and soft constraints.

Furthermore, in accordance with some preferred embodiments of the present invention, said network is the world wide web (WWW).

Furthermore, in accordance with some preferred embodiments of the present invention, there is provided a computer-based apparatus for evaluating a subject, based on presenting a session of evaluation exercises to the subject and automatically evaluating the subject's performance, the apparatus comprising: a server; a data storage provided on said server, said storage provided with database that comprises personal identity data about the subject and an exercise library comprised of a plurality of exercises; processing means provided on said server for processing the subject's performance data and evaluating the subject using a genetic algorithm comprising a fitness evaluation function applied to a set of chromosomes, a chromosome comprising a scoring technique applied to the set of possible exercise sessions to select a suitable exercise session based on the subject's performance; at least one of a plurality of computers having display means and user interface, each computer connected over a network to the server; the computer including a subject assessment module for retrieving a session of exercises from the server and presenting it to the subject on the display means, receiving input from the subject through the user interface, and transmitting the input to the processing means of the server for analyzing, wherein the genetic algorithm operates under constraints.

Furthermore, in accordance with some preferred embodiments of the present invention, said network is the world wide web (WWW).

Furthermore, in accordance with some preferred embodiments of the present invention, each computer is connected to the server via a TCP/IP connection.

Furthermore, in accordance with some preferred embodiments of the present invention, each computer is adapted to transfer and receive information from a local database hosted on the server through a LAN connection.

Furthermore, in accordance with some preferred embodiments of the present invention, a computer keyboard is connected to one of the plurality of computers for the subject to input data into said user interface.

Furthermore, in accordance with some preferred embodiments of the present invention, a computer mouse connected to one of the plurality of computers is provided for the subject to input data into said user interface.

Furthermore, in accordance with some preferred embodiments of the present invention, a touch screen provided on one of the plurality of computers is provided for the subject to input data into said user interface.

Furthermore, in accordance with some preferred embodiments of the present invention, each one of the plurality of computers is provided with a speaker that is adapted to deliver oral instructions regarding a game.

### BRIEF DESCRIPTION OF THE FIGURES

The invention is described herein, by way of example only, with reference to the accompanying Figures, in which like components are designated by like reference numerals.

FIG. 1 illustrates an adaptive computer-based assessment tool in accordance with a preferred embodiment of the present invention.

FIG. 2 is a representative table of data structures for use with a genetic algorithm to generate new session content.

FIG. 3 is a representative table of soft constraints in accordance with a preferred embodiment of the present invention.

FIG. 4 is a representative table of hard constraints in accordance with a preferred embodiment of the present invention.

FIG. 5 is a scheme for implementation of hard constraints in accordance with a preferred embodiment of the present invention.

FIG. 6 is a pseudocode naive implementation of a hard constraint filter in accordance with a preferred embodiment of the present invention.

### DETAILED DESCRIPTION OF THE INVENTION

FIG. 1 illustrates an exemplary computer-based assessment tool, which can be adapted to include the present invention. Server 11 is a computing device, which can operate standalone or on a network such as the Internet, an Intranet, or any other network that can serve a plurality of users. Server 11 is provided with a core program 12 that comprises a genetic algorithm (GA) component 13 and an assessment component 14.

GA component 13 receives from assessment component 14 the user's performance data at various stages of the assessment and evolves for each such stage an optimal or near optimal solution concerning the content to use for the next stage of assessment. Assessment component 14 receives the solution from GA component 13, builds the assessment output using content in database 15 according to the received solution, and sends the assessment output to an input/output unit 17.

Input/output unit 17 can be one or more of various known computer peripherals for enabling a user to communicate with the computer program. For example, a display or speakers for output and a keyboard, a mouse, or a joystick for input. Input/output unit 17 can be implemented in various ways known to the art of computing, such as a dedicated terminal, an independent computer, or part of the same computer as server 11. If physically separate from server 11, input/output unit 17 can be connected to server 11 via various communication links known in the art, such as direct serial or parallel connection or TCP/IP Ethernet connection. Input/Output unit 17 comprises subject assessment content unit 18, wherein assessment information is presented to a subject, for example on a display, and the user's response is received, for example via a keyboard and mouse. Input/Output unit 17 can also comprise facilitator management unit 18, whereby a facilitator can control system feedbehavior,

A detailed example of an adaptive computer-based assessment tool is disclosed by the present inventor, Iyad Suleiman, in United States Patent Application 20040014021. There the tool is adapted for assessment of the school readiness of children. The present invention be integrated into such a tool or into GA-based adaptive computer-based assessment tool adapted for other purposes, such as job-candidate evaluation.

For the purposes of explanation, the present invention is described herein in the context of a GA-based adaptive computer-based assessment tool adapted for assessment of school readiness. It will clear to one skilled in the art that the method and system of the present invention as described herein can be equally implemented for other types of GA-based adaptive computer-based assessment tool.

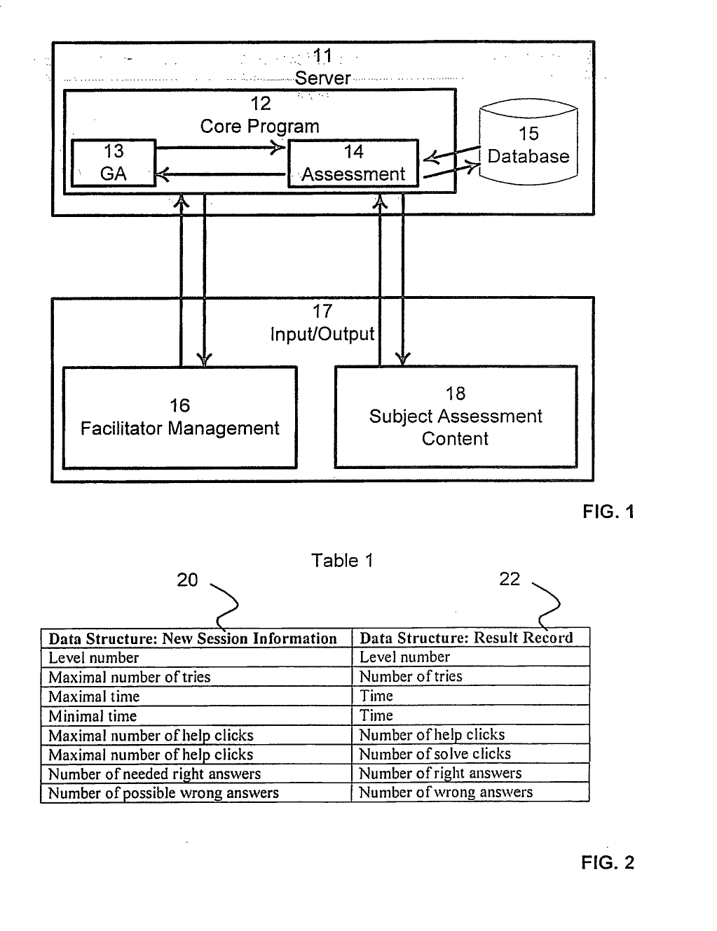

When the subject completes an assessment session, a record 22 (FIG. 2) of the result is passed to GA unit 13, which is in charge of selecting the next session (or group of sessions) for that category of the assessment. Result record 22 includes results of the session and also information about the user (for example, age or experience level) and the difficulty level of the session. Result record 22 is produced from information received by assessment unit 14 from a subject interacting with subject assessment content 18. Result record 22 is used by GA unit 13 to create a chromosome that embeds the performance formula.

GA unit 13 then creates a population based on that chromosome and evolves subsequent generations using mutation and crossover until some stopping criterion is met (typically that a chromosome meets a fitness evaluation threshold or a time limit expires). The fittest chromosome is translated into a record of new session information 20 (FIG. 2). The information is used by assessment unit 14 to select the content from database 15 for the next session.

An exemplary GA algorithm is now summarized. The present invention is not limited to this particular GA algorithm.

There are two main cases: The first case is an assessment system with no memory, in which performance depends only on the most recent result. The second case is an assessment system with n-cell memory in which we evaluate the user's performance according to the last n−1 sessions that he participated in. In the latter case, we can draw information regarding the user's history and his learning curve.

Each chromosome is a suggestion for a choice of content for the next session. The chromosome is a vector of genes that are properties of a session. For instance, the i-th element of the vector, which is the i-th gene in the chromosome, contains the maximal time that the session should last.

The chromosome population consists of a preset number of chromosomes. The speed of convergence of the iterating genetic algorithm depends strongly on the initial population. The range that the initial population covers includes (or come close to including) the current skill of the user, under the assumption that the learning and skill curves are consistent and continuous. If they are not, a regression procedure can be added.

The current skill of the user is drawn from the last game played. Hence, an appropriate chromosome for that game is the base chromosome from which to create the initial population. There are two ways of creating the population of chromosomes: one is according to a uniform distribution around the base chromosome and the other is according to a normal distribution with preset standard deviation parameter vector. Given large enough deviation values, the first generation of chromosomes will contain the user's current state and the appropriate offer with high probability for the next assessment exercise. The standard deviation vector is balanced to the best trade-off empirically.

After the chromosome population is created, the algorithm starts to create new generations in which better chromosomes produce new chromosomes using crossovers and mutations. A chromosome is better than another chromosome when its evaluation value yields better scoring.

The evaluation function is a sum of two terms, the first is a difficulty term and the second is a penalty term.

The difficulty term is a distance function between the chromosome information and the learning curve factor of the user: δ (delta). The target is the chromosome that best achieves minimal distance between the anticipated δ and the difference between the chromosome information and the given results. Furthermore, learning factor δ is adjusted to the user after each activation of the GA. This means that δ is a grade for the improvement the GA anticipates for the user. Of course, when the user is having difficulties with the current skill needs, then δ is negative.

Assuming δ is given, the optimal chromosome Ch will yield the closest improvement to δ. Hence, the fitness evaluation function is such that the difference between the optimal chromosome and the last result is as close a possible to δ. If functions fᵢ are positive metrics, then the optimal chromosome satisfies:

$${min}_{Ch ∈ population} ‖ \begin{matrix}{f}_{1} ( Ch . Level - Re . Level ) + \\ {f}_{2} ( Re . Time - Ch . MaxTime ) + \\ {f}_{3} ( Ch . MaxHelp Clicks - Re . Help Clicks ) + \\ {f}_{4} ( - Re . Tries ) + \\ {f}_{5} ( - Re . Wrongs ) + \\ {f}_{6} ( - Re . Solve Clicks ) + \\ {f}_{7} ( - Re . Exit Clicks ) + \\ - δ\end{matrix} ‖$$

where Ch is the chromosome and Re is the result.

Functions fᵢ can be any loss functions, for example L∞ norm metric functions or L₂ norm metrics.

An alternative method for integrating the improvement factor is an n-cell memory machine, where the last n-results are include in the fitness evaluation procedure and then the embedded δ factor is computed within the fitness evaluation. In this method, the input to the evaluation function is the chromosome as well as the results record that the user achieved interacting with the software. Theoretically, there is no difference between the two methods, since they both use the same amount of information, hence have the same power of computation.

Due to the specific setting of the problem, it is necessary to dictate the occurrence or prevention of several events. These dictates arise from the psychological and logical aspects of the games and the requirements of a reasonable order of the gaming procedure.

Therefore, there is a set of conditions that the user must follow. The modification of a GA to include this set of conditions comprises the present invention, which is now described in more detail.

The conditions are divided into two groups, according to the level of the seriousness of the condition. Some conditions are merely advice to the tester, and can be treated as guidelines for testing the user. Other conditions are a necessity and must be adhered to.

The logical difference between the two kinds of conditions dictate different methods of implementation, hence they are divided into two sets of constraints: soft constraints (SC) that may be broken and hard constraints (HC) that must be satisfied.

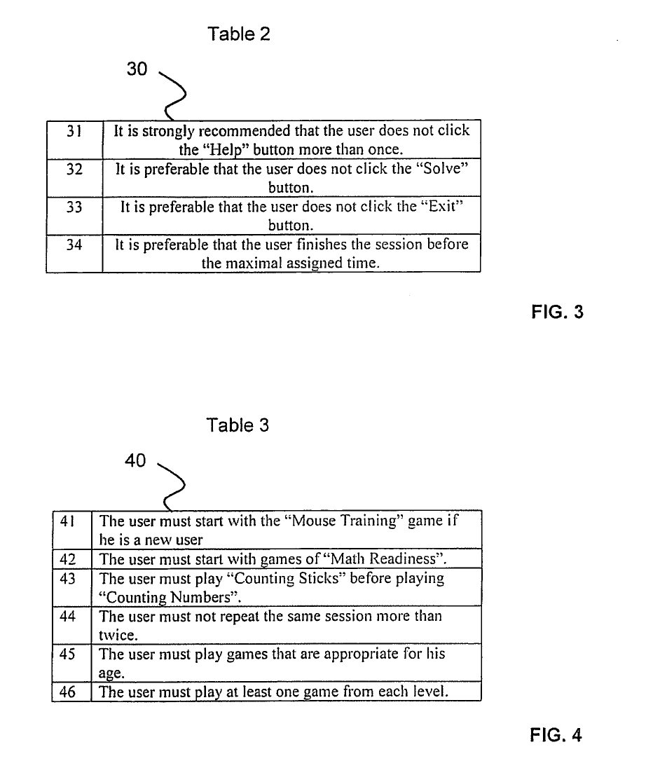

SCs are implemented as a penalty term in the fitness evaluation function. We assign a penalty value for each SC and sum it in the fitness evaluation function when the constraint is violated. A sample list of SCs 30 can be seen in Table 2 (FIG. 3).

The penalty term in the fitness evaluation function is as follows:

$${\sum }_{i = 1}^{\# SCs} C ( i ) \cdot SCB ( i , Chromosome )$$

where #SCs is the number of soft constraints, C(i) is the penalty factor for constraint i and SCB( ) is a Boolean function implemented as follows:

$$SCB ( i , Chromosome ) = \{ \begin{matrix}0 , & Chromosome satisfies SC ( i ) \\ 1 , & otherwise\end{matrix}$$

Hence the fitness evaluation function for a chromosome is:

$$FitnessEvaluation ( Chromosome ) = Difficulty ( Chromosome ) + {\sum }_{i = 1}^{\# SCs} C ( i ) \cdot SCB ( i , Chromosome )$$

As formulated above, there is some redundancy, because certain terms also appear in the SCs penalty term. This does not affect the quality of the solution, since it will only increase the penalty on these terms.

The hard constraints (HCs) are induced from requirements that are presented by the use of “must” or “must not” statements. A representative list of HCs 40 is shown in table 3 (FIG. 4).

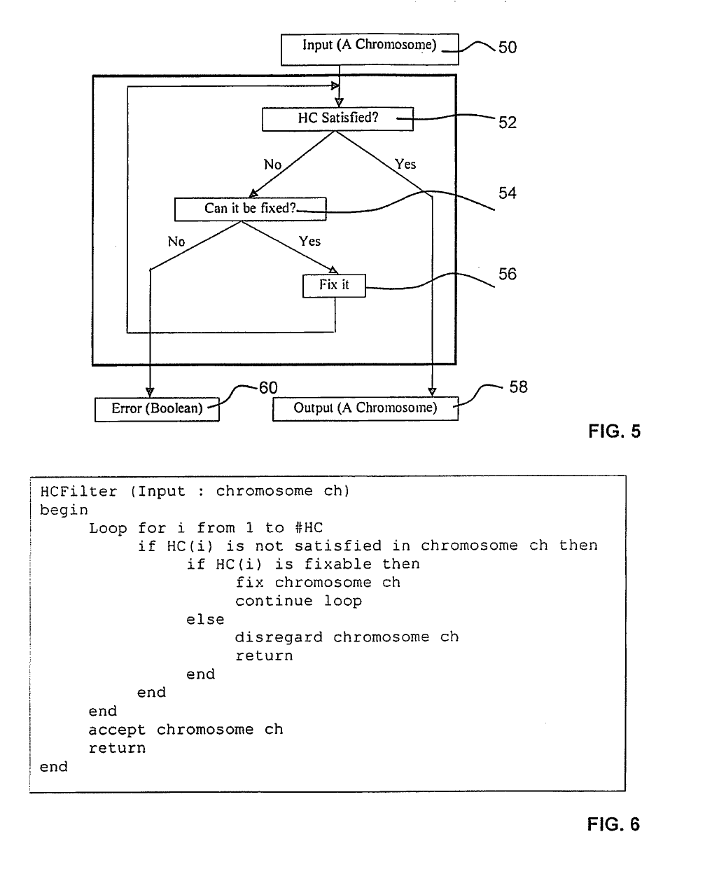

A scheme for implementation of hard constraints is shown in FIG. 5. An input chromosome 50 is checked 52 for satisfying HCs. If it satisfies, the chromome is output 58, if not, it is checked 54 to see whether it can be fixed. If it can, it is fixed 56 and again checked 52 against the HCs, otherwise an error 60 is generated.

FIG. 6 is a pseudocode naive implementation of an HC filter.

The set of HCs are integrated in the system after the best chromosome in the population is chosen. Making an offer for a new session from the chromosome consists of a scoring technique for the set of possible sessions given in a table according to the values of the chromosome genes. The HCs are checked when matching a session for the chromosome. In case one of the HC is not satisfied, then it is made impossible to choose the corresponding session. For example, if HC no. 43 is not satisfied, meaning that we find the game “Counting Sticks” appropriate, but the user hasn't played “Counting Numbers” yet, then we mark it impossible to choose “Counting Sticks” by changing its score.

Some HCs can be satisfied before activating the GA, such as the HC no. 41. In this case we can check if the user is new, skip the GA, and choose the “Mouse Training” game. HC no. 42 is treated similarly.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

What is claimed is:

1. A computer-based method for evaluating a subject, based on presenting a session of evaluation exercises to the subject and automatically evaluating the subject's performance, the method comprising:
providing a server, a data storage provided on said server, said storage provided with database that comprises personal identity data about the subject and an exercise library comprised of a plurality of exercises, processing means on said server for processing the subject's performance data and evaluating the subject and at least one of a plurality of computers having display means and user interface, each computer connected over a network to the server; the computer including a subject assessment module;
retrieving a session of exercises from the server and presenting it to the subject on the display means,
receiving input from the subject through the user interface, and transmitting the input to the processing means of the server for analyzing,
using a genetic algorithm by the server the algorithm comprising a fitness evaluation function applied to a set of chromosomes, a chromosome comprising a scoring technique applied to a set of possible exercise sessions to select a suitable exercise session based on the subject's performance, wherein the genetic algorithm operates under constraints.

2. The method of claim 1, wherein the constraints are soft constraints, wherein a soft constraint comprises a penalty value that is summed into the fitness evaluation function when the constraint is violated.

3. The method as claimed in claim 1, wherein the constraints are hard constraints comprising a set of requirements applied to proposed sessions to filter out sessions that do not meet the set of requirements.

4. The method as claimed in claim 3, wherein the hard constraints are applied at the beginning of the genetic algorithm.

5. The method as claimed in claim 1, wherein the constraints are both hard and soft constraints.

6. The method as claimed in claim 1, wherein said network is the world wide web (WWW).

7. A computer-based apparatus for evaluating a subject, based on presenting a session of evaluation exercises to the subject and automatically evaluating the subject's performance, the apparatus comprising:
a server;
a data storage provided on said server, said storage provided with database that comprises personal identity data about the subject and an exercise library comprised of a plurality of exercises;
processing means provided on said server for processing the subject's performance data and evaluating the subject using a genetic algorithm comprising a fitness evaluation function applied to a set of chromosomes, a chromosome comprising a scoring technique applied to the set of possible exercise sessions to select a suitable exercise session based on the subject's performance;
at least one of a plurality of computers having display means and user interface, each computer connected over a network to the server; the computer including a subject assessment module for retrieving a session of exercises from the server and presenting it to the subject on the display means, receiving input from the subject through the user interface, and transmitting the input to the processing means of the server for analyzing, wherein the genetic algorithm operates under constraints.

8. The apparatus as claimed in claim 7, wherein said network is the world wide web (WWW).

9. The apparatus as claimed in claim 7, wherein each computer is connected to the server via a TCP/IP connection.

10. The apparatus as claimed in claim 7, wherein each computer is adapted to transfer and receive information from a local database hosted on the server through a LAN connection.

11. The apparatus as claimed in claim 7, wherein a computer keyboard is connected to one of the plurality of computers for the subject to input data into said user interface.

12. The apparatus as claimed in claim 7, wherein a computer mouse connected to one of the plurality of computers is provided for the subject to input data into said user interface.

13. The apparatus as claimed in claim 7, wherein a touch screen provided on one of the plurality of computers is provided for the subject to input data into said user interface.

14. The apparatus as claimed in claim 7, wherein each one of the plurality of computers is provided with a speaker that is adapted to deliver oral instructions regarding a game.
